(19) United States
(12) Patent Application Publication
(10) Pub. No.: US 2026/0170447 A1
(43) Pub. Date: Jun. 18, 2026

(54) ORGANIZATION ANALYSIS SYSTEM, ORGANIZATION ANALYSIS METHOD, AND PROGRAM

(71) Applicant: NTT, Inc., Tokyo (JP)

(72) Inventors: Ikuko TAKAGI, Musashino-shi (JP); Hajime NAKAJIMA, Musashino-shi (JP)

(73) Assignee: NTT, Inc., Tokyo (JP)

(21) Appl. No.: 19/128,571

(22) PCT Filed: Nov. 16, 2022
(86) PCT No.: PCT/JP2022/042532

§ 371 Date: May 9, 2025

(51) Int. Cl. G06Q 10/067

(52) U.S. Cl. CPC G06Q 10/067

(57) ABSTRACT

An organization analysis system according to an embodiment includes a model generation unit configured to generate an evaluation model based on contribution value information indicating cooperability between a plurality of members belonging to an organization and autonomy of each of the plurality of members, and an analysis unit configured to perform analysis of cooperability and autonomy using the evaluation model based on query information indicating an evaluation target and an evaluation item.

### TECHNICAL FIELD

Embodiments of the present invention relate to an organization analysis system, an organization analysis method, and a program.

### BACKGROUND ART

An improvement in autonomy is said to promote improvements in work satisfaction and performance. For flexible application to VUCA (Volatility, Uncertainty, Complexity, Ambiguity), companies are interested in increasing the autonomy of their members.

On the other hand, it has been pointed out that an “autonomy paradox” may occur in a collective activity in, such as a company. An autonomy paradox is a phenomenon in which teams and organizations, which are formed for high autonomy, fall into a state where autonomy is strongly restricted as a result of mutual expectation. For this reason, in order to obtain a truly highly autonomous organization, it is important not only to achieve the autonomy of each member but also to create a collaborative environment, such as securing psychological safety and a culture that accepts independent actions.

As an autonomy analysis method, member characteristic analysis is known. In the characteristic analysis, behavior characteristics and performance of members can be analyzed. In the characteristic analysis, a method of performing a questionnaire for an organization or the like on members and classifying organizations into several types based on answer results has been proposed. According to the method, features and problems for each organization are extracted, and recommended improvement measures can be proposed.

Organization network analysis is known as a method of analyzing cooperability. The organization network analysis focuses on the structure of a network between members rather than the attributes of individual members. In the organization network analysis, a method of utilizing, for example, questionnaires performed on members, a history of communication by chatting, mails, and the like, business card data, and the like as data has been proposed. According to the method, it is possible to grasp the density of cooperation between members and to specify a hub human resource.

### CITATION LIST

### Non Patent Literature

[NPL 1] Complete Coherence, <URL:https://complete-coherence.com/complete-organisational-network-analysis-ona/>
[NPL 2] COACH A Co., Ltd., “Announcement of the release of organization network analysis service “Link arc””, <URL: https://www.coacha.com/info/news/20200914.html>
[NPL 3] Panasonic Corporation, “Organization network analysis Solution”, <URL:https://panasonic.co.jp/ew/pewnw/welfeeldo/work_consultation/analitycssolution.html>
[NPL 1] Naoki Maeshirma, “Possibilities for organization network analysis using business card data—Case study of Sansan Labs businessman type analysis—”, <URL: https://www.orsj.org/wp-content/corsj/or64-11/or64_11_655.pdf>
[NPL 5] Plus Alpha Consulting Co., Ltd., “Talent Palette”, <URL: https://www.talent-palette.com/>

### SUMMARY OF INVENTION

### Technical Problem

However, in characteristic analysis, an analysis target is an individual member, and thus there is no mechanism for analyzing cooperability between members. Furthermore, in organization network analysis, an analysis target is a structure based on a relationship between members, and thus there is no mechanism for analyzing autonomy of members. That is, in the methods proposed above, it is difficult to quantitatively analyze both autonomy and cooperability using a single evaluation model.

The present invention has been made in view of the above-described circumstances, and an object thereof is to provide means for quantitatively analyzing both autonomy and cooperability using a single evaluation model.

### Solution to Problem

An organization analysis system according to an aspect includes a model generation unit and an analysis unit. The model generation unit generates an evaluation model based on contribution value information indicating cooperability between a plurality of members belonging to an organization and autonomy of each of the plurality of members. The analysis unit performs analysis of cooperability and autonomy using the evaluation model based on query information indicating an evaluation target and an evaluation item.

### Advantageous Effects of Invention

According to the embodiment, it is possible to provide means for quantitatively analyzing both autonomy and cooperability using a single evaluation model.

### BRIEF DESCRIPTION OF DRAWINGS

FIG. 1 is a block diagram showing an example of a hardware configuration of an organization analysis system according to a first embodiment.

FIG. 2 is a block diagram showing an example of a functional configuration of the organization analysis system according to the first embodiment.

FIG. 3 is a diagram showing an example of a contribution value in contribution value information input to the organization analysis system according to the first embodiment.

FIG. 4 is a diagram showing an example of a configuration of an evaluation model generated by the organization analysis system according to the first embodiment.

FIG. 5 is a diagram showing an example of a configuration of query information input to the organization analysis system according to the first embodiment.

FIG. 6 is a flowchart showing an example of a model generation operation in the organization analysis system according to the first embodiment.

FIG. 7 is a flowchart showing an example of an analysis operation in the organization analysis system according to the first embodiment.

FIG. 8 is a diagram showing an example of a contribution value in contribution value information input to an organization analysis system according to a second embodiment.

FIG. 9 is a diagram showing an example of a configuration of an evaluation model generated by the organization analysis system according to the second embodiment.

FIG. 10 is a flowchart showing an example of a model generation operation in the organization analysis system according to the second embodiment.

### DESCRIPTION OF EMBODIMENTS

Embodiments will be described below with reference to the drawings. In the following description, components having the same function and configuration are denoted by the same reference numerals.

### 1. First Embodiment

### 1.1 Configuration

A configuration of an organization analysis system according to a first embodiment will be described.

### 1.1.1 Hardware Configuration

First, a hardware configuration of the organization analysis system according to the first embodiment will be described.

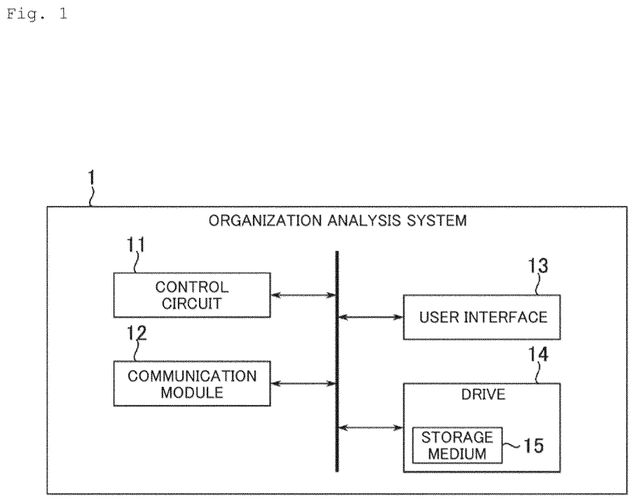

FIG. 1 is a block diagram showing an example of a hardware configuration of an organization analysis system according to a first embodiment. As shown in FIG. 1, an organization analysis system 1 includes a control circuit 11, a communication module 12, a user interface 13, a drive 14, and a storage medium 15.

The control circuit 11 is a circuit for controlling components of the organization analysis system 1 as a whole. The control circuit 11 includes a central processing unit (CPU), a random access memory (RAM), and a read only memory (ROM). The ROM of the control circuit 11 stores programs and the like used for various operations in the organization analysis system 1. The CPU of the control circuit 11 controls the entire organization analysis system 1 in accordance with the programs stored in the ROM of the control circuit 11. The RAM of the control circuit 11 is used as a working area for the CPU of the control circuit 11.

The communication module 12 is a circuit used for transmitting and receiving data to and from the outside of the organization analysis system 1.

The user interface 13 is an interface for performing communication between a user and the control circuit 11. The user interface 13 includes input devices and output devices. The input devices include, for example, a touch panel, operation buttons, and the like. The output devices include, for example, a liquid crystal display (LCD) or an electroluminescence (EL) display. The user interface 13 converts the user's input into an electrical signal and then transmits it to the control circuit 11. The user interface 13 outputs results of execution of various operations based on the user's inputs to the user.

The drive 14 is a device for reading software stored in the storage medium 15. The drive 14 includes, for example, a compact disk (CD) drive and a digital versatile disk (DVD) drive.

The storage medium 15 is a medium that stores software by an electrical, magnetic, optical, mechanical, or chemical action. The storage medium 15 may store programs for executing various operations in the organization analysis system 1.

### 1.1.2 Functional Configuration

A configuration of a communication system according to a first embodiment will be explained.

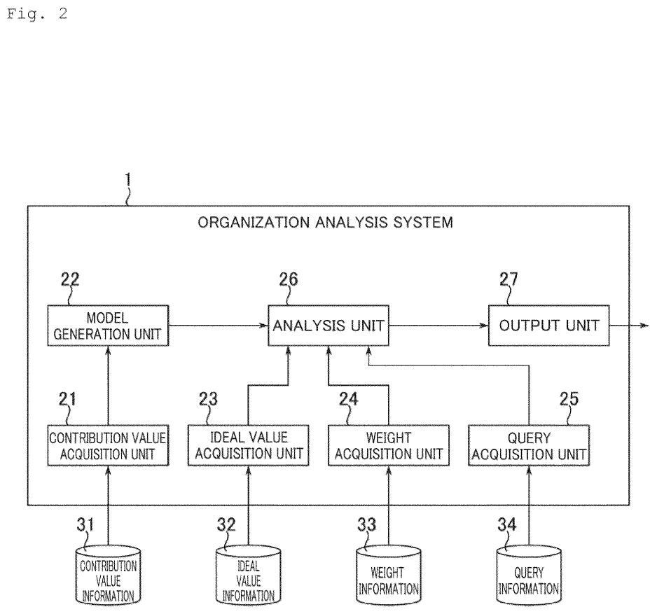

FIG. 2 is a block diagram showing an example of a functional configuration of the organization analysis system according to the first embodiment. The CPU of the control circuit 11 loads a program stored in the ROM of the control circuit 11 or the storage medium 15 into the RAM of the control circuit 11. Then, the CPU of the control circuit 11 interprets and executes the program loaded into the RAM of the control circuit 11. Thereby, the organization analysis system 1 functions as a computer including a contribution value acquisition unit 21, a model generation unit 22, an ideal value acquisition unit 23, a weight acquisition unit 24, a query acquisition unit 25, an analysis unit 26, and an output unit 27.

The contribution value acquisition unit 21 acquires contribution value information 31 from the outside of the organization analysis system 1. The contribution value acquisition unit 21 transmits the contribution value information 31 to the model generation unit 22.

The contribution value information 31 is, for example, questionnaires performed on members, a history of communication by chatting, mails, and the like, business card data, and the like. The contribution value information 31 includes, for example, information regarding autonomy of members and cooperability between members. The information regarding autonomy and cooperability may be positive or negative information. The positive information includes, for example, information indicating that autonomy of members is high and information indicating that cooperability between members is high. The negative information includes, for example, information indicating that autonomy of members is low and information indicating that cooperability between members is low.

The model generation unit 22 generates an evaluation model X based on the contribution value information 31. The evaluation model X is a mathematical model configured to unitarily evaluate autonomy and cooperability of organizations and members. The model generation unit 22 digitizes information on the autonomy of members and the cooperability between members as contribution values included in the contribution value information 31. The model generation unit 22 generates an evaluation model X including contribution values as elements. The model generation unit 22 transmits the generated evaluation model X to the analysis unit 26.

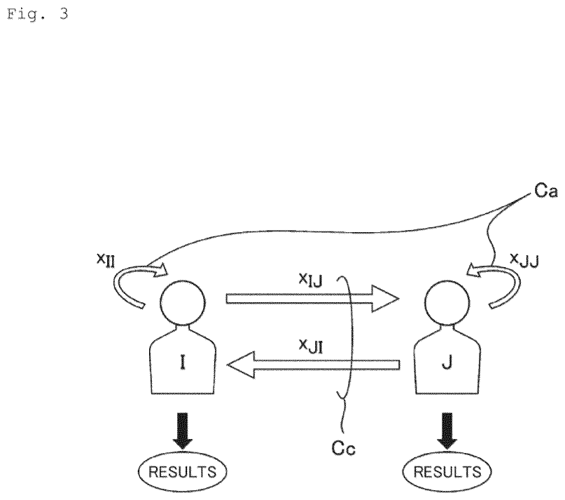

FIG. 3 is a diagram showing an example of a contribution value in contribution value information input to the organization analysis system according to the first embodiment. FIG. 3 shows an example of a contribution value for two members I and J in an organization.

As shown in FIG. 3, the contribution value information 31 includes contribution values x_{IJ}, x_{JI}, x_{II}, and x_{JJ} for members I and J.

The contribution values x_{IJ} and x_{JI} belong to a contribution value Cc indicating cooperability between members. Specifically, the contribution value x_{IJ} indicates a contribution degree in which the member I supports the member J. The contribution value x_{JI} indicates a contribution degree in which the member J supports the member I.

On the other hand, the contribution values x_{II} and x_{JJ} belong to a contribution value Ca indicating autonomy of an individual member. Specifically, the contribution value xxx indicates a contribution degree in which the member I supports himself or herself (that is, the member I). The contribution value x_{JJ} indicates a contribution degree in which the member J supports himself or herself (that is, the member J).

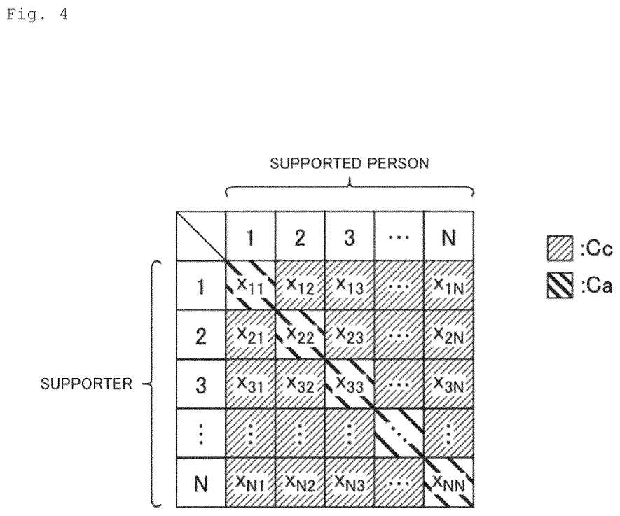

FIG. 4 is a diagram showing an example of a configuration of an evaluation model generated by the organization analysis system according to the first embodiment. FIG. 4 shows an example of an evaluation model X related to an organization having N members (N is an integer of 2 or greater).

As shown in FIG. 4, the evaluation model X is represented, for example, in the form of a matrix of N rows by N columns. Then, a contribution degree (contribution value) in which an i-th member supports a j-th member is assigned to an element xᵢⱼ corresponding to an i-th row and a j-th column of the matrix (1≤i, j≤N).

Each of the rows and each of the columns of the matrix corresponding to the evaluation model X correspond to a supporter and a supported person, respectively. That is, in a case where the variables i and j are different from each other (i≠j), an element xᵢⱼ belongs to a contribution value Cc indicating cooperability between members. On the other hand, in a case where the variables i and j are equal to each other (i=j), the element xᵢⱼ (=xᵢᵢ) belongs to a contribution value Ca indicating autonomy of an individual member.

In the evaluation model X as described above, the contribution values Cc and Ca are digitized within the range of a real number of, for example, −1 or more and 1 or less.

In a case where the contribution value Cc (for example, an element x₁₂) is a positive value, it means that a member 1 is useful for a member 2. This means that the degree of contribution becomes higher as the positive value becomes closer to 1. In a case where the contribution value Cc (for example, an element x₂₁) is a negative value, it means that the member 2 is a burden on the member 1. It means that the degree of contribution becomes lower as the negative value becomes closer to −1. In a case where the contribution value Cc (for example, an element x₁₃) is 0, it means that the member 1 is irrelevant to a member 3.

In a case where the contribution value Ca (for example, an element x₁₁) is a positive value, it means that the member 1 is autonomous. It means that autonomy becomes higher as the positive value becomes closer to 1. In a case where the contribution value Ca (for example, an element x₂₂) is a negative value, it means that the member 2 is not autonomous. It means that autonomy becomes lower as the negative value becomes closer to −1.

Referring back to FIG. 2, a functional configuration of the organization analysis system 1 will be described.

The ideal value acquisition unit 23 acquires ideal value information 32 from the outside of the organization analysis system 1. The ideal value acquisition unit 23 transmits the ideal value information 32 to the analysis unit 26.

The ideal value information 32 is information including an ideal value of a contribution value related to autonomy of members and cooperability between members. The ideal value information 32 is defined in accordance with autonomy and cooperability (that is, the sense of value) expected by an organization. The ideal value information 32 may be a matrix A of N rows by N columns, similar to the evaluation model X. An element aᵢⱼ of an i-th row and a j-th column of the matrix A constituting the ideal value information 32 is, for example, a real number of 0 or more and 1 or less.

The weight acquisition unit 24 acquires weight information 33 from the outside of the organization analysis system 1. The weight acquisition unit 24 transmits the weight information 33 to the analysis unit 26.

The weight information 33 is a parameter for adjusting an analysis result of the analysis unit 26. Similarly to the evaluation model X, the weight information 33 may be a matrix W of N rows by N columns. The element wᵢⱼ of an i-th row and a j-th column of the matrix W constituting the weight information 33 is, for example, a positive real number.

The query acquisition unit 25 acquires query information 34 from the outside of the organization analysis system 1. The query acquisition unit 25 transmits the query information 34 to the analysis unit 26.

The query information 34 includes a character string (query) for specifying an item to be analyzed based on the evaluation model X. The query information 34 is given to the organization analysis system 1, for example, as a user's input.

The analysis unit 26 executes an analysis operation related to autonomy and cooperability in accordance with the ideal value information 32, the weight information 33, and the query information 34 based on the evaluation model X. The analysis unit 26 transmits a result of the analysis operation to the output unit 27. Details of the analysis operation will be described later.

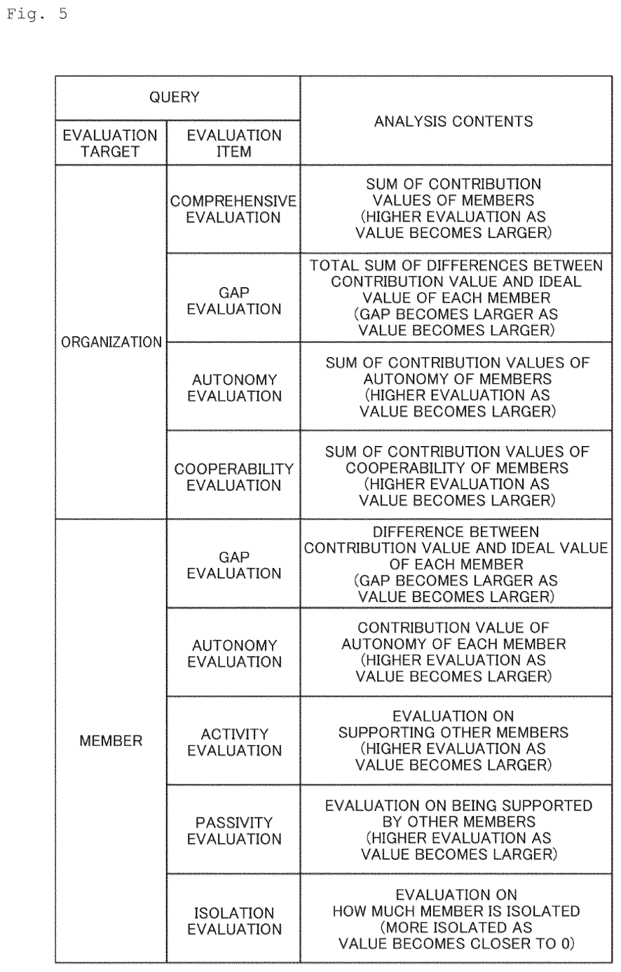

FIG. 5 is a diagram showing an example of a configuration of query information input to the organization analysis system according to the first embodiment. FIG. 5 shows a query and an explanation of items to be analyzed corresponding to the query.

As shown in FIG. 5, the query included in the query information 34 is defined as a set of a query related to an evaluation target and a query related to an evaluation item.

The query related to the evaluation target includes, for example, “organization” and “member”. In a case where the query related to the evaluation target is the “organization”, the query related to the evaluation item includes, for example, “comprehensive evaluation”, “gap evaluation”, “autonomy evaluation”, and “cooperability evaluation”. In a case where the query related to the evaluation target is the “member”, the query related to the evaluation item includes, for example, “gap evaluation”, “autonomy evaluation”, “activity evaluation”, “passivity evaluation”, and “isolation evaluation”.

In a case where the query is the “comprehensive evaluation” of the “organization”, the analysis unit. 26 calculates a sum of contribution values of respective members in the evaluation model X. The analysis unit 26 determines that the “comprehensive evaluation” of the “organization” becomes higher as the calculated value becomes larger.

In a case where the query is the “gap evaluation” of the “organization”, the analysis unit 26 calculates a sum of differences between a contribution value and an ideal value of each member in the evaluation model X. The analysis unit 26 determines that a “gap” from the ideal “organization” becomes larger as the calculated value becomes larger.

In a case where the query is the “autonomy evaluation” of the “organization”, the analysis unit 26 calculates a sum of contribution values of autonomy of respective members in the evaluation model X. The analysis unit 26 determines that the “autonomy” of the “organization” becomes higher as the calculated value becomes larger.

In a case where the query is the “cooperability evaluation” of the “organization”, the analysis unit 26 calculates a sum of contribution values of cooperability of respective members in the evaluation model X. The analysis unit 26 determines that the “cooperability” of the “organization” becomes higher as the calculated value becomes larger.

In a case where the query is the “gap evaluation” of the “member”, the analysis unit 26 calculates a difference between a contribution value and an ideal value of each member in the evaluation model X. The analysis unit 26 determines that the “gap” of the “member” becomes larger as the calculated value becomes larger.

In a case where the query is the “autonomy evaluation” of the “member”, the analysis unit 26 calculates a contribution value of autonomy of each member in the evaluation model X. The analysis unit 26 determines that the “autonomy” of the “member” becomes higher as the calculated value becomes larger.

In a case where the query is the “activity evaluation” of the “member”, the analysis unit 26 calculates an evaluation value related to each member supporting other members in the evaluation model X. The analysis unit 26 determines that the “activity” of the “member” becomes higher as the calculated value becomes larger.

In a case where the query is the “passivity evaluation” of the “member”, the analysis unit 26 calculates an evaluation value related to each member being supported by other members in the evaluation model X. The analysis unit 26 determines that the “passivity” of the “member” becomes higher as the calculated value becomes larger.

In a case where the query is the “isolation evaluation” of the “member”, the analysis unit 26 calculates an evaluation value related to how much each member in the evaluation model X is isolated from other members. The analysis unit 26 determines that the degree of “isolation” of the “member” becomes higher as the calculated value becomes closer to 0.

Returning back to FIG. 2, a functional configuration of the organization analysis system 1 will be described.

When receiving an analysis result, the output unit 27 outputs the analysis result to a user via the user interface 13.

With the above-described configuration, the user can obtain an analysis result on autonomy of an organization and members of the organization, and an analysis result on cooperability of an organization and members of the organization, based on one evaluation model X.

### 1.2 Operations

Next, operations of the organization analysis system according to the first embodiment will be described.

### 1.2.1 Model Generation Operation

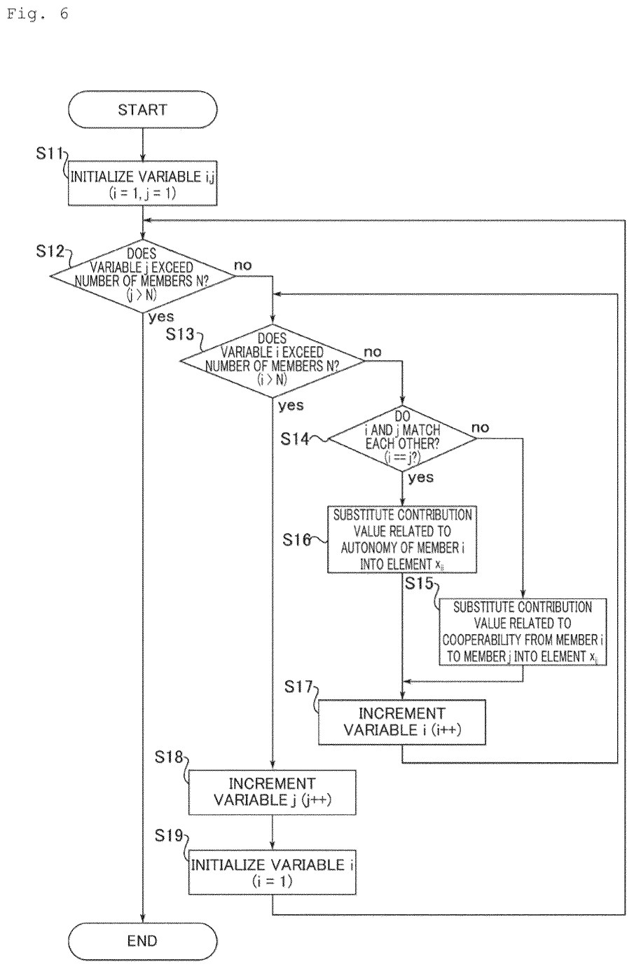

FIG. 6 is a flowchart showing an example of a model generation operation in the organization analysis system according to the first embodiment.

When the contribution value acquisition unit 21 acquires the contribution value information 31 (start), the model generation unit 22 initializes variables i and j to 1 (S11).

The model generation unit 22 determines whether the variable j exceeds the number of members N of an organization related to the contribution value information 31 (S12).

When the variable j is equal to or less than the number of members N (S12; no), the model generation unit 22 determines whether the variable i exceeds the number of members N (S13).

When the variable i is equal to or less than the number of members N (S13; no), the model generation unit 22 determines whether the variable i matches the variable j (S14).

When the variable i and the variable j are different from each other (S14; no), the model generation unit 22 substitutes a contribution value related to cooperability from an i-th member to a j-th member into an element xᵢⱼ (S15).

When the variable i and the variable j match each other (614; yes), the model generation unit 22 substitutes a contribution value related to autonomy of the i-th member into an element xᵢᵢ (S16).

After the process of S15 or the processing of S16, the model generation unit 22 increments the variable i (S17).

After the process of S17, the model generation unit 22 determines whether the variable i exceeds the number of members N (S13). In this manner, the processes of S13 to S17 are repeated until the variable i exceeds the number of members N.

When the variable i exceeds the number of members N (S13; yes), the model generation unit 22 increments the variable j (S18).

After the process of S18, the model generation unit 22 initializes the variable i to 1 (S19).

After the process of S19, the model generation unit 22 determines whether the variable j exceeds the number of members N (S12). In this manner, the processes of S12 to S19 are repeated until the variable j exceeds the number of members N.

When the variable j exceeds the number of members N (S12; yes), the model generation operation ends (end).

### 1.2.2 Analysis Operation

Next, an analysis operation in the organization analysis system according to the first embodiment will be described.

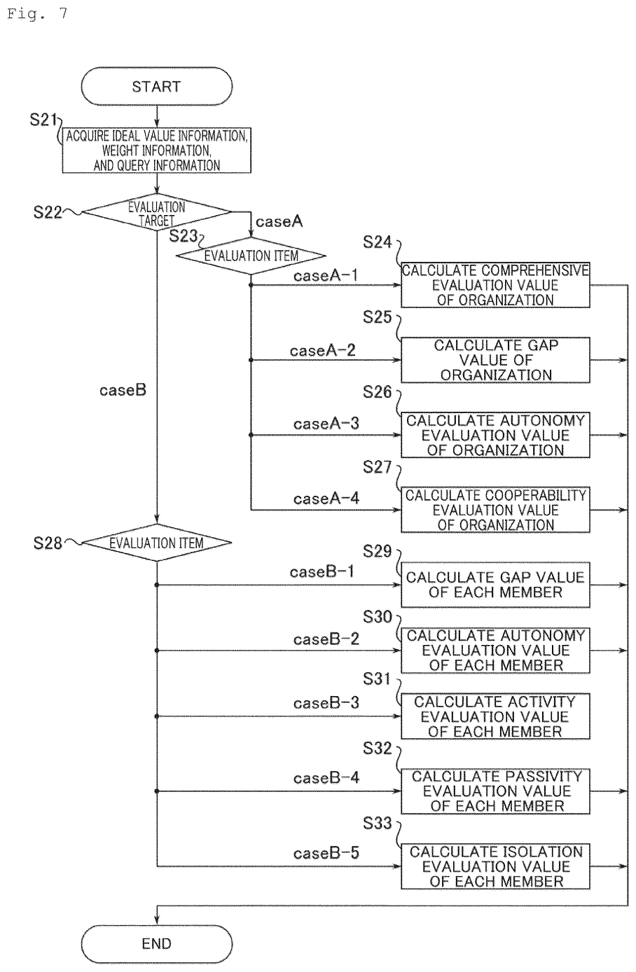

FIG. 7 is a flowchart showing an example of an analysis operation in the organizational analysis system according to the first embodiment. In FIG. 7, it is assumed that the evaluation model X has been generated by a model generation operation.

When the user inputs the ideal value information 32, the weight information 33, and the query information 34 (start), the ideal value acquisition unit 23, the weight acquisition unit 24, and the query acquisition unit 25 acquire the ideal value information 32, the weight information 33, and the query information 34, respectively (S21).

The analysis unit 26 refers to an evaluation target of the query information 34 acquired in the process of S21 (S22). When the evaluation target of the query information 34 is “organization” (S22; case A), the analysis unit 26 refers to an evaluation item of the query information 34 (S23).

When the evaluation item of the query information 34 is “comprehensive evaluation” (S23; case A-1), the analysis unit 26 calculates a comprehensive evaluation value GT of the organization (S24). The comprehensive evaluation value GT of the organization is calculated in accordance with, for example, the following Equation (1).

$$[ Math . 1 ]$$

$$GT = {\sum }_{i} {\sum }_{j} {w}_{ij} {a}_{ij} {x}_{ij} \qquad ( 1 )$$

When the evaluation item of the query information 34 is “gap evaluation” (S23; case A-2), the analysis unit 26 calculates a gap evaluation value GG of the organization (S25). The gap evaluation value GG of the organization is calculated in accordance with, for example, the following Equation (2).

$$[ Math . 2 ]$$

$$GG = {\sum }_{i} {\sum }_{j} \vert {x}_{ij} - {a}_{ij} \vert \qquad ( 2 )$$

When the evaluation item of the query information 34 is “autonomy evaluation” (S23; case A-3), the analysis unit 26 calculates an autonomy evaluation value GA of the organization (S26). The autonomy evaluation value GA of the organization is calculated in accordance with, for example, the following Equation (3).

$$[ Math . 3 ]$$

$$GA = {\sum }_{i} {x}_{ii} \qquad ( 3 )$$

When the evaluation item of the query information 34 is “cooperability evaluation” (S23; case A-4), the analysis unit 26 calculates a cooperability evaluation value GC of the organization (S27). The cooperability evaluation value GC of the organization is calculated in accordance with, for example, the following Equation (4).

$$[ Math . 4 ]$$

$$GC = {\sum }_{i} {\sum }_{j} {x}_{ij} - {\sum }_{i} {x}_{ii} \qquad ( 4 )$$

When the evaluation target of the query information 34 is “member” (S22; case B), the analysis unit 26 refers to an evaluation item of the query information 34 (S28).

When the evaluation item of the query information 34 is “gap evaluation” (S28; case B-1), the analysis unit 26 calculates a gap evaluation value MG of each member (S29). The gap evaluation value MG of each member is calculated in accordance with, for example, the following Equation (5).

$$[ Math . 5 ]$$

$$MG = {\sum }_{j} \vert {x}_{ij} - {a}_{ij} \vert \qquad ( 5 )$$

When the evaluation item of the query information 34 is “autonomy evaluation” (S28; case B-2), the analysis unit 26 calculates an autonomy evaluation value MA of each member (S30). The autonomy evaluation value MA of each member is calculated in accordance with, for example, the following Equation (6).

$$[ Math 6 ]$$

$$MA = {x}_{ii} \qquad ( 6 )$$

When the evaluation item of the query information 34 is “activity evaluation” (S28; case B-3), the analysis unit 26 calculates an activity evaluation value MCA of each member (S31). The activity evaluation value MCA of each member is calculated in accordance with, for example, the following Equation (7).

$$[ Math . 7 ]$$

$$MCA = {\sum }_{j \neq i} {x}_{ij} / {\sum }_{j \neq i} \vert {x}_{ij} \vert \qquad ( 7 )$$

When the evaluation item of the query information 34 is “passivity evaluation” (S28; case B-4), the analysis unit 26 calculates a passivity evaluation value MCP of each member (S32). The passivity evaluation value MCP of each member is calculated in accordance with, for example, the following Equation (8).

$$[ Math . 8 ]$$

$$MCP = {\sum }_{j \neq i} {x}_{ij} / {\sum }_{j \neq i} \vert {x}_{ij} \vert \qquad ( 8 )$$

When the evaluation item of the query information 34 is “isolation evaluation” (S28; case B-5), the analysis unit 26 calculates an isolation evaluation value MCI of each member (S33). The isolation evaluation value MCI of each member is calculated in accordance with, for example, the following Equation (9).

$$[ Math . 9 ]$$

$$MCI = {\sum }_{j \neq i} ( \vert {x}_{ij} \vert + \vert {x}_{ji} \vert ) \qquad ( 9 )$$

When either the processes of S24 to S27 or the processes of S29 to S33 end, the analysis operation ends (end).

A specific example of an analysis operation when the number of members N is five will be described below.

The model generation unit 22 generates an evaluation model Xₑₓ as follows based on the contribution value information 31. Here, the evaluation model Xₑₓ={x₁₁=−0.75, x₁₂=0, x₁₃=0, x₁₄=0, x₁₅=0, x₂₁=1, x₂₂=1, x₂₃=1, x₂₄=0.5, x₂₅=−0.25, x₃₁=1, x₁₂=0.25, x₃₃=0.25, x₃₄=0, x₃₅=0, x₄₃=0, x₄₂=0.5, x₄₃=1, x₄₄=0.75, x₄₅=−0.5, x₅₁=0, x₅₂=0.5, x₅₃=0, x₅₄=0.5, x₅₅=1}.

Furthermore, the ideal value acquisition unit 23 acquires a 5×5 matrix Aₑₓ related to the following ideal values as the ideal value information 32. Here, the matrix Aₑₓ={a₁₁=1, a₁₂=1, a₁₃=1, a₁₄=0, a₁₅=0, a₂₁=1, a₂₂=1, a₂₃=1, a₂₄=1, a₂₅=1, a₃₁=1, a₃₂=1, a₃₃=1, a₃₄=0, a₃₅=0, a₄₁=0, a₄₂=1, a₄₃=1, a₄₄=1, a₄₅=1, a₅₁=1, a₅₂=1, a₅₃=0, a₅₄=1, a₅₅=1}. In the ideal value information 32, ideals and expectations such as “all members are desired to have autonomy”, “a member 1 is desired to support members 2 and 3”, and “a member 5 is desired to support the member 1” are reflected.

Furthermore, the weight acquisition unit 24 acquires a 5×5 matrix Wₑₓ related to weights as the weight information 33. Here, for convenience of description, all elements of the matrix Wₑₓ are set to 1. When all elements of the matrix Wₑₓ and the matrix Aₑₓ are set to 1, this is an analysis operation when no ideal values have been input in advance.

When the analysis operation is performed under the above-described input conditions, the analysis unit 26 obtains the following analysis results.

That is, the comprehensive evaluation value GT of the organization is calculated as GT=7.75. The gap value GP of the organization is calculated as GP=11.25. The autonomy evaluation value GA of the organization is calculated as GA=2.25. The cooperability evaluation value GC of the organization is calculated as GC=5.5.

Gap evaluation values MG1 to MG5 of the respective members 1 to 5 are calculated as MG1=3.75, MG2=1.75, MG3=1.5, MG4=2.25, and MG5=2, respectively. Autonomy evaluation values MA1 to MA5 of the respective members 1 to 5 are calculated as MA1=−0.75, MA2=1, MA3=0.25, MA4=0.75, and MA5=1, respectively. Activity evaluation values MCA1 to MCA5 of the respective members 1 to 5 are calculated as MCA1=0, MCA2=0.82, MCA3=1, MCA4=0.5, and MCA5=1, respectively. Passivity evaluation values MCP1 to MCP5 of the respective members 1 to 5 are calculated as MCP1=1, MCP2=1, MCP3=1, MCP4=1, and MCP5=−1, respectively. Isolation evaluation values MCI1 to MCI5 of the respective members 1 to 5 are calculated as MCI1=2, MCI2=4, MCI3=3.25, MCI4=3, and MCI5=1.75, respectively.

When the above-described analysis results are output from the output unit 27, the user can understand that the member I has low autonomy and activity. The user can also understand that the member 5 has low passivity and high isolation. The user can also understand that the members 2 to 4 have high cooperability.

### 1.3. Effects According to First Embodiment

According to the first embodiment, the model generation unit 22 generates the evaluation model X based on the contribution value information 31 indicating cooperability among a plurality of members belonging to an organization and autonomy of each of the plurality of members. The analysis unit 26 performs analysis related to cooperability and autonomy using the evaluation model X based on the ideal value information 32 indicating ideal values of cooperability and autonomy, and the query information 34 indicating an evaluation target and evaluation items. Specifically, the evaluation model X includes, as the contribution value Ca indicating autonomy, the element x₁₁ indicating the autonomy of the member 1 and the element x₂₂ indicating the autonomy of the member 2. Furthermore, the evaluation model X includes, as the contribution value Cc indicating cooperativity, the element x₁₂ indicating cooperativity from the member 1 to the member 2 and the element x₂₁ indicating cooperativity from the member 2 to the member 1. Thereby, the analysis unit 26 can analyze both cooperability and autonomy from the single evaluation model X. For this reason, quantitative analysis can be performed in consideration of a balance between autonomy and cooperability.

Furthermore, when the evaluation target included in the query information 34 indicates an organization, the analysis unit 26 analyze cooperability and autonomy of the organization. Specifically, when the evaluation target indicates an organization, the analysis unit 26 performs analysis for the organization with respect to at least one evaluation item selected from among the comprehensive evaluation of cooperability and autonomy, the gap evaluation, the autonomy evaluation, and the cooperability evaluation from the ideal value information 32. Thereby, it is possible to perform quantitative analysis of cooperability and autonomy for the entire organization from the single evaluation model X.

Furthermore, when the evaluation target included in the query information 34 indicates a member, the analysis unit 26 analyzes cooperability and autonomy of the member. Specifically, when the evaluation target indicates a member, the analysis unit 26 performs analysis for the member with respect to at least one evaluation item selected from among the gap evaluation, the autonomy evaluation, and the cooperability evaluation from the ideal value information 32. More specifically, when the cooperability evaluation is performed, the analysis unit 26 analyzes at least one evaluation item of the activity evaluation, the passivity evaluation, and the isolation evaluation. Thereby, it is possible to perform quantitative analysis of cooperability and autonomy of each member from the single evaluation model X.

### 2. Second Embodiment

Next, an organization analysis system according to a second embodiment will be described. The second embodiment differs from the first embodiment in that an evaluation model X is generated for each task executed in an organization. Configurations and operations different from those in the first embodiment will be mainly described below. Descriptions of configurations and operations equivalent to those in the first embodiment will be omitted as appropriate.

### 2.1 Evaluation Model

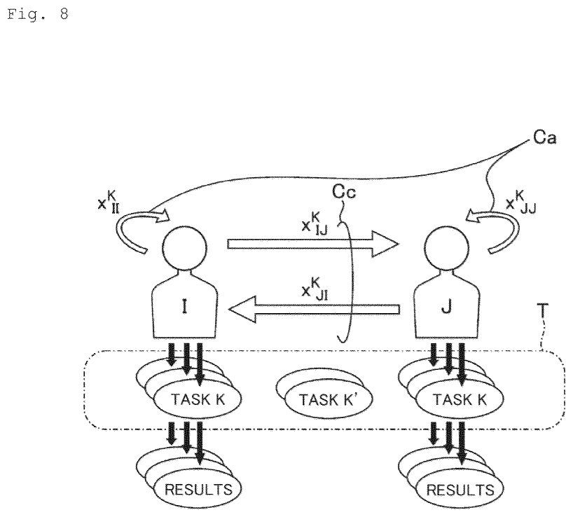

FIG. 8 is a diagram showing an example of a contribution value in contribution value information input to the organization analysis system according to the second embodiment. FIG. 8 corresponds to FIG. 3 in the first embodiment.

As shown in FIG. 8, contribution value information 31 includes contribution values x^{X}_{IJ}, x^{K}_{JI}, x^{K}_{II}, and x^{K}_{JJ} for members I and J who execute a task K. The task K is one task included in a task group T executed by each member in an organization.

The contribution values x^{K}_{IJ} and x^{K}_{JI} belong to a contribution value Cc indicating cooperability between members executing the task K. Specifically, the contribution value x^{K}_{IJ} indicates a contribution degree in which the member I executing the task K supports the member J executing the task K. The contribution value x^{K}_{JI} indicates a contribution degree in which the member J executing the task K supports the member I executing the task K.

On the other hand, the contribution values x^{K}_{II} and x^{K}_{JJ} belong to a contribution value Ca indicating autonomy of an individual member who executes the task K. Specifically, the contribution value x^{K}_{II} indicates a contribution degree in which the member I executing the task K supports himself or herself (that is, the member I). The contribution value x^{K}_{JJ} indicates a contribution degree in which the member J executing the task K supports himself or herself (that is, the member J).

For a task K′ which is not executed by any of the members I and J among the tasks included in the task group T, contribution values related to the members I and J are not generated. That is, contribution values x^{X′}_{IJ}, x^{K′}_{JI}, x^{K′}_{II}, and x^{K′}_{JJ} are all zero.

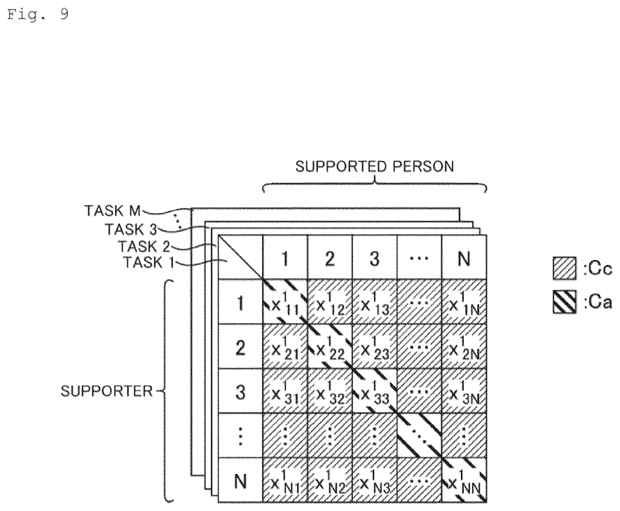

FIG. 9 is a diagram showing an example of a configuration of an evaluation model generated by the organization analysis system according to the second embodiment. FIG. 9 shows an example of an evaluation model X related to an organization having N members who execute M tasks (M and N are integers of 2 or greater).

As shown in FIG. 9, the evaluation model X is represented, for example, in the form of M independent matrices of N rows by N columns. One matrix corresponds to one task. Then, a contribution degree (contribution value) in which an i-th member executing a k-th task supports a j-th member executing the k-th task is assigned to an element x^{k}ᵢⱼ corresponding to an i-th row and a j-th column of a k-th matrix (1≤i, j≤N, 1≤k≤M).

Rows and columns of each matrix corresponding to the evaluation model X correspond to supporters and supported persons, respectively. That is, when the variables i and j are different from each other (i≠j), the element x^{k}ᵢⱼ belongs to the contribution value Cc indicating cooperability between members, regardless of the value of the variable k. On the other hand, when the variables i and j are equal to each other (i=j), the element x^{k}ᵢⱼ (=x^{k}ᵢᵢ) belongs to the contribution value Ca indicating autonomy of an individual member, regardless of the value of the variable k.

In the evaluation model X as described above, the contribution values Cc and Ca are digitized within the range of a real number of, for example, −1 or more and 1 or less.

In a case where the contribution value Cc (for example, an element x¹₁₂) is a positive value, it means that a member 1 executing a task 1 is useful for a member 2 executing the task 1. It means that the degree of contribution becomes higher as the positive value becomes closer to 1. In a case where the contribution value Cc (for example, an element x¹₂₁) is a negative value, it means that the member 2 executing the task 1 is a burden on the member 1 executing the task 1. It means that the degree of contribution becomes lower as the negative value becomes closer to −1. In a case where the contribution value Cc (for example, an element x¹₁₃) is 0, it means that the member 1 executing the task 1 is irrelevant to a member 3 executing the task 1.

In a case where the contribution value Ca (for example, an element x¹₁₁) is a positive value, it means that the member 1 autonomously executes the task 1. It means that autonomy becomes higher as the positive value becomes closer to 1. In a case where the contribution value Ca (for example, an element x¹₂₂) is a negative value, it means that the member 2 does not autonomously execute the task 1. It means that autonomy becomes lower as the negative value becomes closer to −1.

### 2.2 Model Generation Operation

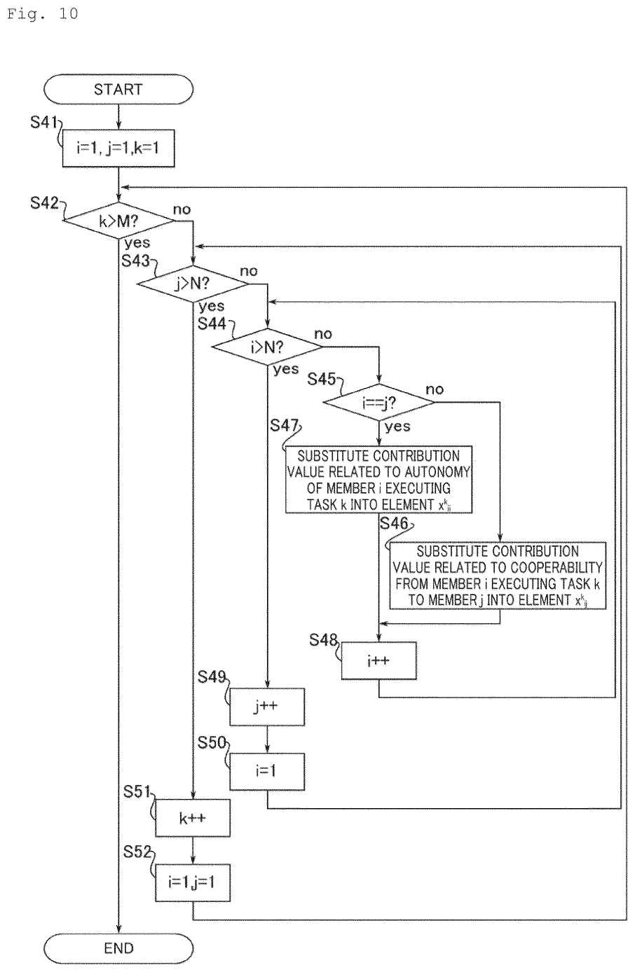

FIG. 10 is a flowchart showing an example of a model generation operation in the organization analysis system according to the second embodiment. FIG. 10 corresponds to FIG. 6 in the second embodiment.

When a contribution value acquisition unit 21 acquires the contribution value information 31 (start), a model generation unit 22 initializes variables i, j, and k to 1 (S41).

The model generation unit 22 determines whether the variable k exceeds the number of tasks M related to the contribution value information 31 (S42).

When the variable k is equal to or less than the number of tasks M (S42; no), the model generation unit 22 determines whether the variable j exceeds the number of members N (S43).

When the variable i is equal to or less than the number of members N (S43; no), the model generation unit 22 determines whether the variable i exceeds the number of members N (S44).

When the variable i is equal to or less than the number of members N (S44; no), the model generation unit 22 determines whether the variable i matches the variable j (S45).

When the variable i and the variable j are different from each other (S45; no), the model generation unit 22 assigns a contribution value related to cooperativity from the i-th member executing the k-th task to the j-th member executing the k-th task to the element x^{k}ᵢⱼ (S46).

When the variable i and the variable j match each other (S45; yes), the model generation unit 22 substitutes a contribution value related to autonomy of the i-th member executing the k-th task into the element x^{k}ᵢᵢ (S47).

After the process of S46 or S47, the model generation unit 22 increments the variable i (S48).

After the process of S48, the model generation unit 22 determines whether the variable i exceeds the number of members N (S44). In this manner, the processes of S44 to S48 are repeated until the variable i exceeds the number of members N.

When the variable i exceeds the number of members N (S44; yes), the model generation unit 22 increments the variable j (S49).

After the process of S49, the model generation unit 22 initializes the variable i to 1 (S50).

After the process of S50, the model generation unit 22 determines whether the variable j exceeds the number of members N (S43). In this manner, the processes of S43 to S50 are repeated until the variable j exceeds the number of members N.

When the variable j exceeds the number of members N (S43; yes), the model generation unit 22 increments the variable k (S51).

After the process of S51, the model generation unit 22 initializes the variables i and j to 1 (S52).

After the process of S52, the model generation unit 22 determines whether the variable k exceeds the number of tasks M (S42). In this manner, the processes of S42 to S52 are repeated until the variable k exceeds the number of tasks M.

When the variable k exceeds the number of tasks M (S42; yes), the model generation operation ends (end).

### 2.3. Effects According to Second Embodiment

According to the second embodiment, the model generation unit 22 generates the evaluation model X for each task group T executed by an organization. An analysis unit 26 analyzes cooperability and autonomy by using a single evaluation model X generated for each of tasks. Thereby, even when cooperability between members and autonomy of each member are changed for each task, appropriate quantitative analysis can be performed.

### 3. Others

Various modifications can be made to the first and second embodiments described above.

In the first and second embodiments described above, a case where programs for executing a model generation operation and an analysis operation are executed by the organization analysis system 1 has been described, but the present invention is not limited thereto. For example, the programs for executing the model generation operation and the analysis operation may be executed by computing resources on the cloud.

The present invention is not limited to the above-described embodiments and can be modified in various forms without departing from the gist of the present invention at an implementation stage. The embodiments may be combined as appropriate. In this case, combined effects can be achieved. Further, the above-described embodiments include various aspects of the invention, and the various aspects of the invention can be extracted by combinations selected from a plurality of disclosed constituent elements. For example, even when some of all the constituent elements disclosed in the embodiments are deleted, a configuration from which the constituent elements are deleted can be extracted as an aspect of the invention as long as the problems can be solved and the effects can be obtained.

### REFERENCE SIGNS LIST

1 Organization analysis system
11 Control circuit
12 Communication module
13 User interface
14 Drive
15 Storage medium
21 Contribution value acquisition unit
22 Model generation unit
23 Ideal value acquisition unit
24 Weight acquisition unit
25 Query acquisition unit
26 Analysis unit
27 Output unit
31 Contribution value information
32 Ideal value information
33 Weight information
34 Query information

1. An organization analysis system comprising processing circuitry configured to:
generate an evaluation model based on contribution value information indicating cooperability between a plurality of members belonging to an organization and autonomy of each of the plurality of members; and
perform analysis of cooperability and autonomy using the evaluation model based on query information indicating an evaluation target and an evaluation item.

2. The organization analysis system according to claim 1, wherein the evaluation model includes;
a first contribution value indicating autonomy of a first member,
a second contribution value indicating autonomy of a second member,
a third contribution value indicating cooperability from the first member to the second member, and
a fourth contribution value indicating cooperability from the second member to the first member.

3. The organization analysis system according to claim 1, wherein the processing circuitry is configured to:
perform analysis of cooperability and autonomy for an organization in a case where the evaluation target indicates the organization, and
perform analysis of cooperability and autonomy for each of the plurality of members when the evaluation target indicates the plurality of members.

4. The organization analysis system according to claim 3, wherein the processing circuitry is configured to:
perform analysis for the organization with respect to at least one evaluation item selected from among comprehensive evaluation of cooperability and autonomy, gap evaluation, autonomy evaluation, and cooperability evaluation when the evaluation target indicates the organization.

5. The organization analysis system according to claim 3, wherein the processing circuitry is configured to:
perform analysis for each of the plurality of members with respect to at least one evaluation item selected from among gap evaluation, autonomy evaluation, activity evaluation, passivity evaluation, and isolation evaluation when the evaluation target indicates the plurality of members.

6. The organization analysis system according to claim 1, wherein the processing circuitry is configured to:
generate the evaluation model for each of a plurality of tasks executed by the organization, and
perform analysis of cooperability and autonomy by using the evaluation model generated for each of the plurality of tasks.

7. An organization analysis method comprising:
generating an evaluation model based on contribution value information indicating cooperability between a plurality of members belonging to an organization and autonomy of each of the plurality of members; and
performing analysis of cooperability and autonomy using the evaluation model based on query information indicating an evaluation target and an evaluation item.

8. A non-transitory computer-readable storage medium storing a program for causing a computer to:
generate an evaluation model based on contribution value information indicating cooperability between a plurality of members belonging to an organization and autonomy of each of the plurality of members; and
perform analysis of cooperability and autonomy using the evaluation model based on query information indicating an evaluation target and an evaluation item.
